(19) United States
(12) Patent Application Publication
(10) Pub. No.: US 2026/0178475 A1
(43) Pub. Date: Jun. 25, 2026

(54) Server System, Configuration Method, CPU, Control Module, and Non-volatile Readable Storage Medium

(71) Applicant: SUZHOU METABRAIN INTELLIGENT TECHNOLOGY CO., LTD., Suzhou, Jiangsu (CN)

(72) Inventors: Jun YANG, Suzhou, Jiangsu (CN); Tiejun LIU, Suzhou, Jiangsu (CN); Peiqiang DONG, Suzhou, Jiangsu (CN)

(73) Assignee: SUZHOU METABRAIN INTELLIGENT TECHNOLOGY CO., LTD., Suzhou, Jiangsu (CN)

(21) Appl. No.: 19/125,065

(22) PCT Filed: Sep. 29, 2024
(86) PCT No.: PCT/CN2024/122513

§ 371 Date: Apr. 28, 2025

(30) Foreign Application Priority Data
Oct. 9, 2023 (CN) 202311300080.8

(51) Int. Cl. G06F 12/02; G06F 1/3203; G06F 9/50

(52) U.S. Cl. CPC G06F 12/023; G06F 1/3203; G06F 9/5016

(57) ABSTRACT

A server system, a configuration method, a CPU, a control module, and a non-volatile readable storage medium are provided. The server system includes: a plurality of CPUs, each CPU being provided with at least one bus interface; at least one data transmission bus, each CPU being connected to at least one data transmission bus through a corresponding bus interface; a plurality of extended memories; and a compute express link switch (CXL Switch), the CXL Switch being connected to each CPU through a first-type interface and connected to each of the plurality of extended memories through a second-type interface; and the CXL Switch is configured to connect a data path between a target extended memory and a target CPU under an indication of a connection signal, so as to allocate the target extended memory to the target CPU.

### CROSS-REFERENCE TO RELATED APPLICATION

The disclosure claims the priority to Chinese Patent Application No. 202311300080.8, filed with the Chinese Patent Office on Oct. 9, 2023 and entitled “Server system, configuration method, CPU, control module, and non-volatile readable storage medium”, which is incorporated in its entirety herein by reference.

### TECHNICAL FIELD

Examples of the disclosure relate to the field of servers, and in particular to a server system, a configuration method, a CPU, a control module, and a non-volatile readable storage medium.

### BACKGROUND

There are different types of servers, such as tower servers, rack servers, blade servers, and cabinet servers. A central processing unit (CPU) is tightly coupled to a memory regardless of the server types. Moreover, a plurality of CPUs in the server are generally connected through a multi-path interconnection technology. In the presence of a large number of CPUs, indirect connection between the CPUs is inescapable in such a connection mode (for example, a first CPU can be connected to a third CPU only by means of a second CPU). However, the indirect connection mode limits a speed of data transmission between the CPUs, and affects performance of the server owing to fixed storage resources of the CPUs in the server.

### SUMMARY

Examples of the disclosure provide a server system, a configuration method, a CPU, a control module, and a non-volatile readable storage medium, so as to solve at least a problem that performance of the server is affected in the related art owing to indirect connection between CPUs in a server and fixed storage resources of the CPUs in the server.

A server system is provided according to some examples of the disclosure. The server system includes: a plurality of central processing units (CPUs), wherein each of the plurality of CPUs is provided with at least one bus interface; at least one data transmission bus, wherein each of the plurality of CPUs is connected to one or more of the at least one data transmission bus through one or more corresponding bus interfaces of the at least one bus interface, and any two of the plurality of CPUs are configured to transmit data through one or more of the at least one data transmission bus; a plurality of extended memories based on a compute express link (CXL); and a compute express link switch (CXL Switch), which has an memory resource allocation module, wherein the CXL Switch is provided with a first-type interface and a second-type interface, and the CXL Switch is connected to each of the plurality of CPUs through the first-type interface and connected to each of the plurality of extended memories through the second-type interface; the CXL Switch is configured to connect a target extended memory with a target CPU via a data path under an indication of a connection signal, so as to allocate the target extended memory to the target CPU; and the target extended memory is one or more of the plurality of extended memories, and the target CPU is one of the plurality of CPUs.

According to some examples of the disclosure, the CXL Switch includes: a plurality of CXL sub-Switches in cascaded, wherein each of the plurality of CXL sub-Switches is provided with the first-type interface and the second-type interface; one CXL sub-Switch of the plurality of CXL sub-Switches is connected to each of the plurality of CPUs through the first-type interface of the one CXL sub-Switch, and one CXL sub-Switch of the plurality of CXL sub-Switches is connected to each of the plurality of extended memories through the second-type interface of the one CXL sub-Switch; and the second-type interface of a CXL sub-Switch at a first level of two mutually-cascaded levels is connected to the first-type interface of a CXL sub-Switch at a second level of the two mutually-cascaded levels.

According to some examples of the disclosure, the server system further includes: a control module, wherein the control module is connected to each of the plurality of extended memories, the CXL Switch, and each of the plurality of CPUs respectively, and the control module is configured to allocate a corresponding extended memory to each of the plurality of CPUs, and the control module is further configured to combine at least one of the plurality of CPUs and at least one of the plurality of extended memories into a server unit, to obtain a plurality of server units, so that one or more functions are implemented through the plurality of server units.

According to some examples of the disclosure, the server system further includes: a front panel; a backplane; and a CPU board, wherein the CPU board is sandwiched between the front panel and the backplane, the plurality of CPUs and the at least one data transmission bus are integrated in the CPU board, and the CPU board is connected to the backplane through a first board interface positioned on the backplane.

According to some examples of the disclosure, the server system further includes: one or more memory boards, wherein a plurality of extended memories and a CXL Switch are integrated on the one or more memory boards, and each of the one or more memory boards is sandwiched between the front panel and the backplane, and each of the one or more memory boards is connected to the backplane through a second board interface positioned on the backplane.

According to some examples of the disclosure, the server system further includes: a control board, wherein a control module is integrated on the control board, and the control board is sandwiched between the front panel and the backplane; and the control board is connected to the backplane through a third board interface positioned on the backplane, and the control module is connected to each of the plurality of extended memories, the CXL Switch, and each of the plurality of CPUs respectively.

According to some examples of the disclosure, the server system further includes: a power source board, wherein the power source board is sandwiched between the front panel and the backplane, and the power source board is connected to the backplane through a fourth board interface positioned on the backplane, and the power source board is configured to provide electrical energy for the server system.

According to some examples of the disclosure, a display unit and a control switch are integrated on the front panel.

A configuration method applied to a CPU in the server system is provided according to some other examples of the disclosure. The method includes: determining whether to transmit data between a first CPU and a second CPU, wherein the first CPU and the second CPU are any two of the plurality of CPUs; determining whether an idle data transmission bus is available in a case that the data are to be transmitted between the first CPU and the second CPU; and transmitting, in a case that the idle data transmission bus is available, the data between the first CPU and the second CPU through the idle data transmission bus.

According to some examples of the disclosure, the transmitting, in a case that the idle data transmission bus is available, the data between the first CPU and the second CPU through the idle data transmission bus includes: selecting, in a case that a plurality of idle data transmission buses are available, one idle data transmission bus from the plurality of idle data transmission buses; and transmitting the data between the first CPU and the second CPU through the one idle data transmission bus which is selected from the plurality of idle data transmission buses.

According to some examples of the disclosure, the determining whether an idle data transmission bus is available includes: acquiring a level signal at a preset position of each data transmission bus; and determining whether the each data transmission bus is the idle data transmission bus according to the level signal at the preset position of the each data transmission bus.

A configuration method applied to a control module in the server system is provided according to some examples of the disclosure, the server system further comprises a control module, and the control module is connected to each of the plurality of extended memories, the CXL Switch, and each of the plurality of CPUs respectively; and the configuration method includes: initializing the CXL Switch; detecting and saving a port number of each of the plurality of CPUs connected to the first-type interface; detecting and saving a port number of each of the plurality of extended memories connected to the second-type interface; creating a memory resource pool, and adding the plurality of extended memories to the memory resource pool; and acquiring one or more corresponding extended memories from the memory resource pool according to performance demand, and allocating the one or more extended memories acquired to a corresponding CPU of the plurality of CPUs based on the port number of each of the plurality of CPUs and the port number of each of the one or more extended memories.

According to some examples of the disclosure, the method further includes: determining whether a use rate of one or more extended memories allocated to a target CPU of the plurality of CPUs exceeds a preset use rate, wherein the use rate indicates a proportion of the number of one or more extended memories being used by the target CPU to a total number of the one or more extended memories allocated to the target CPU, and/or a proportion of a space of the one or more extended memories being used by the target CPU to a total space of the on or more extended memories allocated to the target CPU;

and applying for one or more new extended memories from the memory resource pool for the target CPU in a case that the use rate exceeds the preset use rate.

According to some examples of the disclosure, after the applying for one or more new extended memories from the memory resource pool for the target CPU, the method further includes: determining whether an idle extended memory is available in the memory resource pool, and if the idle extended memory is available in the memory resource pool, acquiring the idle extended memory from the memory resource pool, and acquiring a port number of the idle extended memory; and acquiring a port number of the target CPU, and matching the port number of the idle extended memory with the port number of the target CPU, so as to allocate the idle extended memory to the target CPU.

According to some examples of the disclosure, the method further includes: determining whether an idleness rate of each of the one or more extended memories allocated to a target CPU exceeds a preset idleness rate, wherein the idleness rate indicates a proportion of unused space of each of the one or more extended memories allocated to the target CPU to total space of each of the one or more extended memories allocated to the target CPU; and releasing, in a case that the idleness rate exceeds the preset idleness rate, an allocation relation between one or more extended memories, of each of which the idleness rate exceeds the preset idleness rate, and the target CPU.

According to some examples of the disclosure, the releasing an allocation relation between the one or more extended memories, of each of which the idleness rate exceeds the preset idleness rate, and the target CPU includes: performing a power off operation on the one or more extended memories of each of which the idleness rate exceeds the preset idleness rate; and reclaiming the one or more extended memories on which the power off operation is performed into the memory resource pool, so as to release the allocation relation between the one or more extended memories, of which the idleness rate exceeds the preset idleness rate, and the target CPU.

According to some examples of the disclosure, the releasing an allocation relation between the one or more extended memories, of each of which the idleness rate exceeds the preset idleness rate, and the target CPU includes: determining an extended memory, of which the idleness rate is highest, from the one or more extended memories, of each of which the idleness rate exceeds the preset idleness rate; and releasing an allocation relation between the extended memory, of which the idleness rate is highest, and the target CPU.

According to some examples of the disclosure, the method further includes: combining at least one of the plurality of CPUs and at least one of the plurality of extended memories into one server unit, so as to obtain a plurality of server units; and controlling the plurality of server units to be run in parallel to implement one or more functions.

A CPU in the server system is provided according to yet some other examples of the disclosure. The CPU includes: a first determination unit configured to determine whether to transmit data between a first CPU and a second CPU, wherein the first CPU and the second CPU are any two of the plurality of CPUs; a second determination unit configured to determine whether an idle data transmission bus is available in a case that the data are to be transmitted between the first CPU and the second CPU; and a transmission unit configured to transmit, in a case that the idle data transmission bus is available, the data between the first CPU and the second CPU through the idle data transmission bus.

A control module in the server system is provided according to yet some other examples of the disclosure. The server system further includes a control module, and the control module is connected to each of the plurality of extended memories, the CXL Switch, and each of the plurality of CPUs separately; and the control module includes: an initialization unit configured to initialize the CXL Switch;

a first detecting and saving unit configured to detect and save a port number of each of the plurality of CPUs connected to the first-type interface; a second detecting and saving unit configured to detect and save a port number of each of the plurality of extended memories connected to the second-type interface; a creation unit configured to create a memory resource pool, and add the plurality of extended memories to the memory resource pool; and an allocation unit configured to acquire one or more corresponding extended memories from the memory resource pool according to performance demand, and allocate the one or more extended memories acquired to a corresponding CPU based on the port number of each of the plurality of CPUs and the port number of each of the plurality of extended memories.

A non-volatile readable storage medium is further provided according to still some other examples of the disclosure. The non-volatile readable storage medium stores a computer program, where the computer program executes steps in any method example described above when run.

Through the disclosure, according to the solution of the disclosure, direct connection between any two CPUs is implemented in a data transmission bus connection mode. Thus, a too large transmission step size of indirect connection between the CPUs is solved, and a speed of data transmission between the CPUs is improved. Correspondingly, limitation to a number of the CPUs in such a connection mode of the disclosure is far less than that of the solution in the related art. In other words, the speed of data transmission is taken into account while the number of the CPUs is increased. Moreover, the extended memory and the compute express link switch (CXL Switch, which has an memory resource allocation module) are arranged, so that storage resources of the CPU are flexibly configured, and performance superiorities of the server are ensured.

### BRIEF DESCRIPTION OF THE DRAWINGS

FIG. 1 is a schematic diagram of a first server system according to an example of the disclosure;

FIG. 2 is a schematic diagram of a second server system according to an example of the disclosure;

FIG. 3 is a schematic diagram of a connection mode between central processing units (CPUs) in the related art;

FIG. 4 is a schematic diagram of another connection mode between CPUs in the related art;

FIG. 5 is a schematic diagram of a third server system according to an example of the disclosure;

FIG. 6 is a schematic diagram of a cascaded connection mode of a compute express link switch according to an example of the disclosure;

FIG. 7 is a schematic diagram of a fourth server system according to an example of the disclosure;

FIG. 8 is a schematic diagram of a fifth server system according to an example of the disclosure;

FIG. 9 is a schematic diagram of a sixth server system according to an example of the disclosure;

FIG. 10 is a flowchart of a configuration method applied to a CPU according to an example of the disclosure;

FIG. 11 is a flowchart of an optional configuration method applied to a CPU according to an example of the disclosure;

FIG. 12 is a flowchart of a configuration method applied to a control module according to an example of the disclosure;

FIG. 13 is a flowchart of an optional configuration method applied to a control module according to an example of the disclosure;

FIG. 14 is a flowchart of a method involved in a use rate according to an example of the disclosure;

FIG. 15 is a flowchart of a method involved in an idleness rate according to an example of the disclosure;

FIG. 16 is a schematic diagram of a CPU according to an example of the disclosure; and

FIG. 17 is a schematic diagram of a control module according to an example of the disclosure.

The above accompanying drawings include the reference numerals as follows:
10. front panel; 20. backplane; 30. CPU board; 40. memory board; 50. control board; 60. power source board; 31. first board interface; 41. second board interface; 51. third board interface; and 61. fourth board interface.

### DETAILED DESCRIPTION OF THE EMBODIMENTS

Examples of the disclosure will be described in detail below in conjunction with the accompanying drawings and the examples.

It should be noted that the terms “first”, “second”, etc. in the description, the claims, and the above accompanying drawings of the disclosure are used to distinguish between similar objects, instead of necessarily describing a particular sequence or a successive order.

It should be understood that data used in this way can be interchanged where appropriate, so as to facilitate the examples described herein of the disclosure. In addition, the terms “comprise”, “include”, “is provided with”, and their any variations are intended to cover non-exclusive inclusion. For example, a process, method, system, product, or device encompassing a series of steps or units can include other steps or units that are not explicitly listed or are inherent to the process, method, product, or device, without being limited to those steps or units explicitly listed.

It should be understood that when an element (such as a layer, film, region, or substrate) is described as being “on” another element, the element can be directly on another element, and alternatively, intervening elements can be present. Moreover, in the description and the claims, when an element is described as being “connected” to another element, the element can be “directly connected” to another element or “connected” to another element through a third element.

For the sake of description, some nouns or terms involved in the examples of the disclosure are described below:

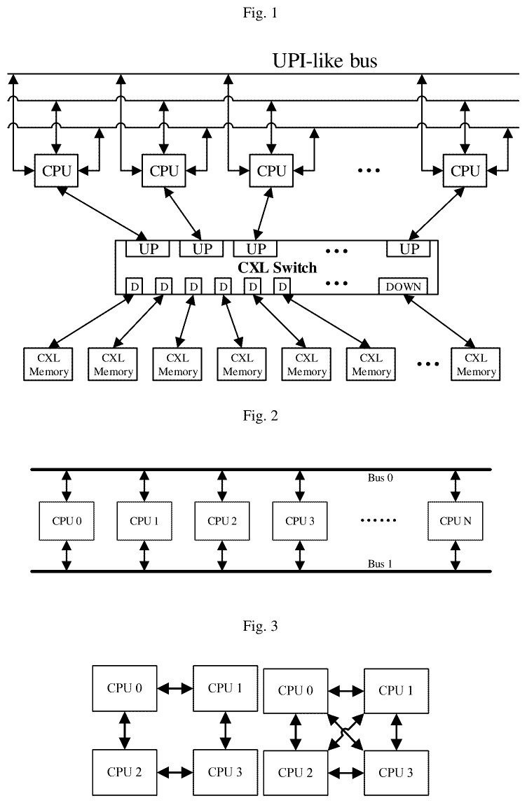

In a first aspect, a server system is provided in the examples of the disclosure. As shown in FIG. 1, the server system includes:
a plurality of central processing units (CPUs), where each of the plurality of CPUs is provided with at least one bus interface; where
a number of the CPUs is limited by a structure and performance of the server system itself, and a number of the bus interface on each CPU is limited by a structure and performance of the CPU; and in other words, the number of the CPUs and the number of the bus interface on each CPU are not infinitely increased; and
at least one data transmission bus, where each of the plurality of CPUs is connected to one or more of the at least one data transmission bus through one or more corresponding bus interfaces of the at least one bus interface, and any two of the plurality of CPUs are configured to transmit data through one or more of the at least one data transmission bus.

In some examples, a total number of the bus interfaces of each CPU is greater than or equal to a total number of the data transmission buses.

In a case that a total number of the bus interfaces of each CPU is equal to a total number of the data transmission buses, the total number of the data transmission buses is set based on the total number of the bus interfaces of each CPU. For example, if one CPU is provided with three bus interfaces, three data transmission buses are correspondingly arranged.

In a case that a total number of the bus interfaces of each CPU is greater than a total number of the data transmission buses, if one CPU is provided with three bus interfaces, two data transmission buses are correspondingly arranged, and one bus interface is idle.

In some examples, ultra path interconnect (UPI)-like bus and a UPI-like interface structure may be selected as the bus and the bus interface of the CPU in the disclosure respectively.

In some examples, each of N CPUs in the server system shown in FIG. 2 is provided with two bus interfaces. Correspondingly, two buses, i.e. a bus 0 and a bus 1 are arranged.

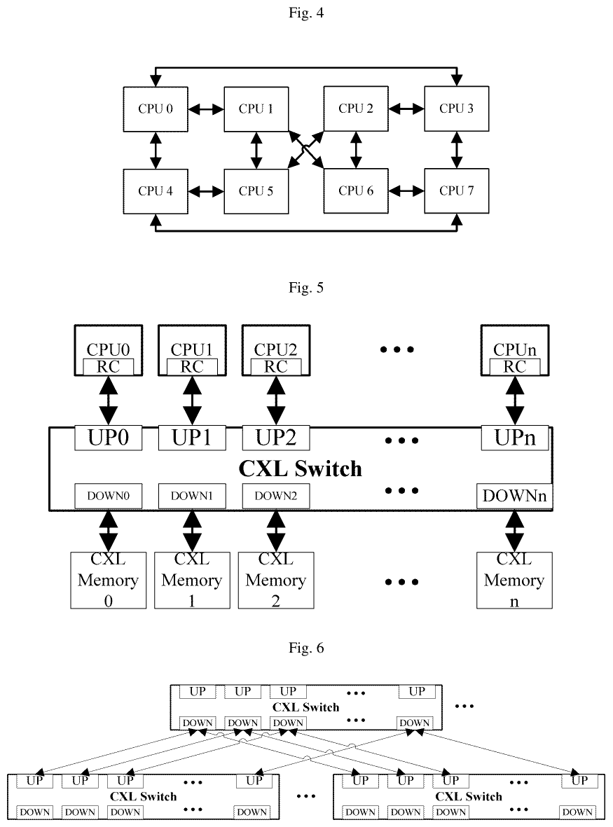

FIGS. 3 and 4 show connection modes of CPUs in the related art. With Intel's ultra path interconnect (UPI) as an example, if each CPU is provided with two UPI paths, a connection mode among four CPUs is shown in a left portion of FIG. 3 as follows:
two adjacent CPUs (such as a CPU 0 and a CPU 1) are directly connected with a step size of 1. Diagonally-opposite CPUs (such as the CPU 0 and a CPU 3) are indirectly connected with a step size of 2.

If direct connections (i.e. with the step size of 1) between any two of the four CPUs is required, the CPU must be provided with three UPI paths, as shown in a right portion of FIG. 3.

Efficiency of data transmission of the direct connection between the CPUs is obviously higher than that of indirect connection. However, UPI resources on the CPU are limited, and cannot be infinitely increased. If there are an increasingly number of CPUs in the server, indirect connection between the CPUs is inevitable. If the CPU is provided with three UPI paths with a maximum connection step size of 2, eight CPUs can be supported at most, and a connection mode of the CPUs is shown in FIG. 4.

It can be seen from the above that a point-to-point connection mode between the CPUs, a maximum number of UPI paths of the CPU, and a maximum step size of the indirect connection between the CPUs determine a maximum number of CPUs in the server. However, if the connection step size of the CPU is too large, the speed of data transmission between the CPUs is unacceptable. In consequence, the number of the CPUs in the server is limited.

For the UPI connection mode, in the solution of the disclosure, the connection mode of the CPU is modified, the UPI of the CPU is directly connected to the UPI of another CPU originally. After modification, the CPU is also provided with a structure similar to the UPI, but such a UPI-like structure is directly connected to the bus. The CPU may be provided with a plurality of UPI-like interfaces. In other words, CPUs may be connected through a plurality of buses. Certainly, connection modes other than UPI are also based on the same implementation principle.

Quick path interconnect (QPI) and HyperTransport used in Intel and AMD respectively are point-to-point connection.

The principle of time division multiplexing is utilized based on a bus mode.

The server system further includes a plurality of extended memories.

The compute express link (CXL), a type of high-speed interconnect technology, can provide high-bandwidth and low-delay connection between a processor of a computer host and an accelerator, a memory buffer region, an intelligent input/output device, etc. The CXL can be configured for high-speed and low-delay connection between the CPU in the computer host and a graphics processing unit (GPU), a hard disk (such as a mechanical hard disk, a solid state hard disk, and a hybrid hard disk), and a network card (such as a standard network card and an intelligent network card), and high-speed and low-delay connection between computer hosts, or between the computer host and a memory resource pool (such as an external hard disk), a GPU resource pool, etc. For example, a plurality of processors, accelerators, memories, etc. may be connected via high-speed passages, providing a higher bandwidth and lower delay and improving computation efficiency. Essentially, the CXL technology maintains memory consistency between CPU memory space and a memory on a device connected. This supports resource sharing (or pooling) for higher performance, lowers complexity of a software stack, and reduces overall system costs. Data may be transmitted between a peripheral component interface express (PCIe) passage and a memory through the CXL technology, providing better memory access and management. Moreover, computation and storage resources can be shared, so that complexity and a cost of a data center are lowered.

The server system further includes a compute express link switch (CXL Switch, which can be called as a computer expansion interconnection network switching device), which has an memory resource allocation module, where a computer device using the CXL can perform interconnection between the processor and the external device through, but not limited to, the computer expansion interconnection network switching device (CXL Switch). The CXL Switch supports the processor of the computer host in being connected to more devices. Thus, resources (such as computation resources, storage resources, and network transmission resources) are allocated from the external device connected (such as the GPU, the hard disk, and the network card) to the processor of the computer host according to workload requirements of the processor of the computer host connected, so that resource utilization is improved, and the overall system costs are reduced. The CXL Switch in the disclosure is provided with a first-type interface and a second-type interface, where the CXL Switch is connected to each CPU through the first-type interface, the memory resource allocation module in the CXL Switch is connected to each CXL Memory (namely, extended memory) through the second-type interface; the CXL Switch is configured for connection of a data path between a target extended memory and a target CPU under an indication of a connection signal, so as to allocate the target extended memory to the target CPU; and the target extended memory indicates one or more of the plurality of extended memories, and the target CPU indicates one of the plurality of CPUs.

The connection signal is sent out by the control module in the CPU. The compute express link switch (CXL Switch) realizes the connection of the data path between the target extended memory and the target CPU under the indication of the connection signal, so that resources are allocated to the target CPU.

In some examples, one or more sub-servers (i.e. server units) are configured through a control module on a control board. In other words, the CPU, the extended memory, and other external devices are physically connected into an independently-operable whole. A connection mode between the CPU and the extended memory is as follows: a PCIRootComplex on the CPU is connected to an uplink port of the CXL Switch, and the extended memory is connected to a downlink port of the CXL Switch. The CXL Switch is configured to connect the CPU and the extended memory, and enable the two ports simultaneously. After the power source board is energized, the control board may energize the CPU through a control signal line connected to the CPU. After energized, the CPU is initialized at first, and then initializes a bus controller, including the PCIRootComplex carrying a CXL protocol. After initialized, the RC detects the extended memory connected to the CPU, and load the corresponding drive to initialize the extended memory. Thus, the CPU and the extended memory connected to the CPU are loaded. The extended memory is hot-swappable while the system is running. Before the extended memory is inserted, a slot for the extended memory is in a deenergized state, and the downlink port of the CXL Switch corresponding to and connected to the slot for the extended memory is also in a disabled state. After the extended memory is inserted, the control module enables the downlink port connected to the extended memory, makes the slot in an energized state, and then notifies the CPU. In this case, the PCIRootComplex on the CPU detects the extended memory, triggers an operating system to load the drive of the extended memory, so as to complete initialization, and adds the extended memory to the memory resource pool for use. To remove the extended memory, the control module sends a request to remove the extended memory to the CPU at first. The operating system transfers a program run on the extended memory to another memory at first, and deletes the memory device from the memory resource pool; then triggers the drive to execute deinitialization; and finally closes the downlink port for the slot, and removes the extended memory after a power source for the slot is disconnected.

In some examples, as shown in FIG. 5, the first-type interface is shown as an interface UP, and the second-type interface is shown as an interface DOWN. Also, the advent of the extended memory leads to the possibility of decoupling a tight relation between the CPU and the memory.

With the above arrangement, the compute express link switch allocates the extended memory to the CPU under the instruction of the connection signal. For example, a CXL memory 0 and a CXL memory 1 are allocated to the CPU 0, a CXL memory 2 is allocated to the CPU 1, a CXL memory 4 and a CXL memory 5 are allocated to a CPU 3 . . . . In other words, memory resources are dynamically allocated to the CPU according to actual demand. Since a sufficient number of memory resources are configured for the CPU, data transmission between the CPUs can be reduced, a busy state of the bus can be correspondingly reduced, and the speed of data transmission between the CPUs can be improved.

The extended memory CXL memory in the disclosure may indicate, but is not limited to, a memory extended board and a persistent memory device without local cache. The extended memory CXL memory may provide access to the memory for the CPU of the computer host by loading and storing commands through a CXL.io protocol and a CXL.memory protocol. The extended memory CXL memory may support volatile and persistent memory architectures. The extended memory CXL memory may be a dedicated storage device that communicates with the CPU of the computer host, and can implement low-delay and high-throughput data transmission through the CXL protocol. The extended memory CXL memory may be used as a memory buffer, or may indicate an extended memory bandwidth and a memory capacity.

The above CXL.io protocol, a type of enumeration configuration protocol, may be used as a basic communication protocol for device discovery, enumeration, error reporting, etc. In such a mode, the computer host may extend the memory to the external device, making the speed of data transmission higher. For example, the CPU and the external device supporting the protocol may be connected through a bus including, but not limited to, a PCIe bus. The CPU may share the memory with the external device, and may directly access an input/output (I/O) resource of the external device. Thus a lower delay, a higher bandwidth, and better extendibility are achieved. The CXL.memory protocol, a type of memory protocol, provides access to a memory of the external device for the processor of the computer host by loading and storing commands. In this case, the CPU of the computer host acts as a master device, the external device acts as a slave device, and volatile and persistent memory architectures can be supported. In such a mode, the computer host may use the external device as a main memory, thereby achieving higher memory capacity. In a CXL.memory mode, the CPU of the computer host is allowed to regard the external device as the extended memory, so that more data can be stored. In this way, reliability of the system can be improved. Even if a memory failure occurs, the CPU of the computer host can still continue operating through the external device.

In other words, according to the solution of the disclosure, the direct connection between any two CPUs is implemented in the bus connection mode. Thus, a too large transmission step size of the indirect connection between the CPUs is solved, and the speed of data transmission between the CPUs is improved. Correspondingly, limitation to the number of the CPUs in such a connection mode of the disclosure is far less than that of the solution in the related art. In other words, the speed of data transmission is taken into account while the number of the CPUs is increased. Moreover, the extended memory and the compute express link switch (CXL Switch) are arranged, so that the storage resources of the CPU are flexibly configured, and in other words, superiorities in transmission speed are ensured in the bus connection mode. Even if the data in the CPU are increased by allocating the extended memory to the CPU, the data can be transmitted in time, and performance superiorities of the server can be ensured.

Further, the compute express link switch includes:
a plurality of CXL sub-Switches in cascaded, wherein each of the plurality of CXL sub-Switches is provided with the first-type interface and the second-type interface; one CXL sub-Switch of the plurality of CXL sub-Switches is connected to each of the plurality of CPUs through the first-type interface of the one CXL sub-Switch, and one CXL sub-Switch of the plurality of CXL sub-Switches is connected to each of the plurality of extended memories through the second-type interface of the one CXL sub-Switch; and the second-type interface of a CXL sub-Switch at a first level of two mutually-cascaded levels is connected to the first-type interface of a CXL sub-Switch at a second level of the two mutually-cascaded levels.

As shown in FIG. 6, for three CXL sub-Switches, a first CXL sub-Switch is cascaded with a second CXL sub-Switch and a third CXL sub-Switch separately. In other words, an UP port at the topmost layer is connected to the CPU, and the DOWN port at the bottommost layer is connected to the extended memory extension device.

For example, with the connection mode in FIG. 5, three CXL memories can be allocated to one CPU in a time period only. However, with the connection mode in FIG. 6, six CXL memories can be allocated to the CPU in the time period. In other words, without affecting implementation of functions of other CPUs, more CXL memories can be allocated to the CPU. Thus, normal implementation of the functions is ensured, and time consumed by waiting for the idle CXL memories is shortened.

With the above cascaded arrangement mode, more extended memories are allocated to the CPU. In other words, more memory resources can be allocated to the CPU relative to a non-cascaded arrangement mode, so as to adapt to implementation of richer functions of the server. The above connection mode provides the basis for pooling of the CPU and the extended memory.

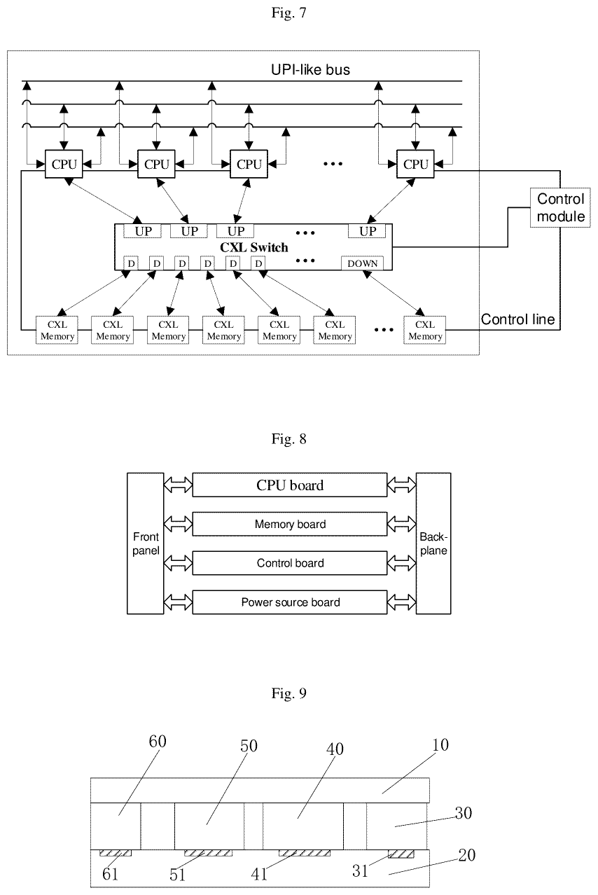

Further, as shown in FIG. 7, the server system further includes:
a control module, wherein the control module is connected to each of the plurality of extended memories, the CXL Switch, and each of the plurality of CPUs respectively, and the control module is configured to allocate a corresponding extended memory to each of the plurality of CPUs, and the control module is further configured to combine at least one of the plurality of CPUs and at least one of the plurality of extended memories into a server unit, to obtain a plurality of server units, so that one or more functions are implemented through the plurality of server units.

For example, if a bank system is intended to implement a deposit function, a withdrawal function, and a financial management function, with the solution in the related art, it is required to set at least one independent server system for the deposit function, at least one independent server system for the withdrawal function, and at least one independent server system for the financial management function.

In other words, the deposit function, the withdrawal function, and the financial management function are implemented through a plurality of server systems. However, with the solution of the disclosure, the plurality of server units are obtained by combining the CPU and the extended memory, and the plurality of server units are positioned in a same server system. In other words, the three functions are implemented simultaneously by one device, so that space is saved, and a cost is reduced.

In some examples, a baseboard management controller (BMC), a single-chip microcomputer, etc. may be selected as the control module.

According to the above, at least one CPU and at least one extended memory are combined into one server unit according to the performance demand, so as to obtain the plurality of server units. Thus, one server system has the functions of a plurality of conventional servers. In other words, a server combination architecture is simplified, and corresponding functions are implemented while the space is saved on. Moreover, a number of servers in the data center and routing complexity between the servers are further reduced due to a high degree of integration of the CPU and the extended memory. In other words, an entire machine may be configured as one server unit or a plurality of server units. For such a server model, since a large number of CPUs and memories can be integrated in one machine, the layout of the servers in the data center can be greatly optimized, the speed of data transmission between the servers can be increased, and external connection lines between the servers can be reduced.

As described above, the novel server based on the CXL realizes pooling of hardware resources of the CPU and the extended memory, so that the combination of the CPU and the extended memory extension device can be flexibly managed and configured through the control module. One machine may be combined into one or more servers as demanded. Since the CPU and the extended memory in the server are highly integrated, the number of the servers in the data center and the routing complexity between the servers are reduced.

In some implementations, in a case that the functions to be implemented are complex, the priority of the functions to be implemented may be ranked, and execution time of the functions to be implemented may also be ranked. Then, an order of configuring the server units for each function may be determined according to a priority ranking result and a time ranking result. For example, the server units are preferably configured for each function in a successive order of the execution time. In a case of identical execution time, the server units are configured for the function having higher priority at first, and then the server units are configured for the function having lower priority.

In some implementations, in a case that the functions to be implemented are complex, a number of spare extended memories in the server unit configured for the function having higher priority is greater than that of spare extended memories in the server unit configured for the function having lower priority. Thus, reliability of implementation of the function having higher priority is ensured.

As shown in FIGS. 8 and 9, the server system further includes:
a front panel 10;
a backplane 20; and
a CPU board 30, where the CPU board 30 is sandwiched between the front panel 10 and the backplane 20, the plurality of CPUs and the at least one data transmission bus are integrated in the CPU board 30, and the CPU board 30 is connected to the backplane 20 through a first board interface 31 positioned on the backplane 20.

One or more CPU boards may be provided.

In some examples, the CPU board is composed of a plurality of CPUs, each CPU may have its own independent memory, the extended memory may be completely released, and the extended memory takes a role when a large number of storage resources are required. The extended memory is released in an idle state.

A number of CPUs may be placed in a single board, but each CPU may be independently controlled. The entire machine may be provided with a plurality of single CPU boards and connected to other devices in the machine through the backplane. The energization of all the CPUs is controlled by the control board. The CPU board may also be hot-swappable.

A server apparatus of the disclosure includes the above server system. In addition to the functions of the above server system, the server apparatus also increases the degree of integration of the server apparatus by arranging the front panel, the backplane, the CPU board, etc. as a whole. In other words, even if the complex functions are intended to be implemented, the server apparatus of the disclosure can implement such functions without building up a complex server architecture.

As shown in FIGS. 8 and 9, the server system further includes:
one or more memory boards 40, where a plurality of extended memories and a compute express link switch are integrated on the one or more memory boards, and each of the one or more memory boards is sandwiched between the front panel 10 and the backplane 20 and connected to the backplane through a second board interface 41 positioned on the backplane. The compute express link switch is connected to each CPU through the first-type interface and connected to each extended memory through the second-type interface.

In some examples, an extended memory board is composed of the CXL Switch and the extended memory extension device. The CPU is connected to the extended memory extension device through the CXL Switch, and supports a hot-swappable function. After the control board connects the CPU to the extended memory extension device, and energizes the CPU and the extended memory extension device, the CPU detects the extended memory extension device, and loads the system. It is also possible to energize the extended memory extension device after the CPU loads the system completely. When no longer needing the extended memory, the CPU unloads and removes the extended memory, and notifies the control board. The control board puts the extended memory in a resource pool for subsequent use. The extended memory board may be hot-swappable.

In some examples, the extended memory board is selected as the memory board. Since the plurality of extended memories and the compute express link switch are integrated in the memory board, the memory board in the disclosure has functions of the extended memory and the compute express link switch.

As shown in FIGS. 8 and 9, the server system further includes:
a control board 50, where the control module is integrated on the control board, and the control board is sandwiched between the front panel 10 and the backplane 20; and the control board is connected to the backplane through a third board interface 51 positioned on the backplane, and the control module is connected to each of the plurality of extended memories, the compute express link switch, and each of the plurality of CPUs respectively.

In some examples, the control module may be connected to each extended memory, the compute express link switch, and each CPU through a data bus, such as an inter-integrated circuit (I2C) bus and a bus.

Similar to the BMC of an existing server, the control board is responsible for control and configuration management of the CPU, the extended memory extension device, etc. The connection between the CPU and the extended memory extension device is configured as follows: the control board combines all the CPUs and the extended memory extension device into one computer system. Alternatively, the control board may configures some CPUs and the extended memory extension device into a plurality of computer systems as demanded.

As described above, since the control module is integrated in the control board, the control board has functions of the control module. The control module is connected to the CPU, the extended memory, and the compute express link switch through a connection line, so that the memory resources are configured for each CPU.

As shown in FIGS. 8 and 9, the server system further includes:
a power source board 60, where the power source board is sandwiched between the front panel 10 and the backplane 20 and the power source board is connected to the backplane through a fourth board interface 61 positioned on the backplane, and the power source board is configured to provide electrical energy for the server system.

As described above, the power source board is arranged to supply power to the control board, the memory board, the front panel, and the backplane in the server apparatus, so as to ensure normal operation of each component of the server apparatus.

Further, a display unit and a control switch are further integrated on the front panel. The display unit may be an indicator lamp, and different display states of the indicator lamp indicate different results implemented by the function. The control switch may realize linkage control with the control board, the memory board, etc. For example, when the control switch is turned on, the control board and the memory board are enabled, and when the control switch is turned off, the control board and the memory board do not work.

In some examples, PCIe interfaces are selected as the first board interface, the second board interface, the third board interface, and the fourth board interface. Thus, interconnection between boards is implemented.

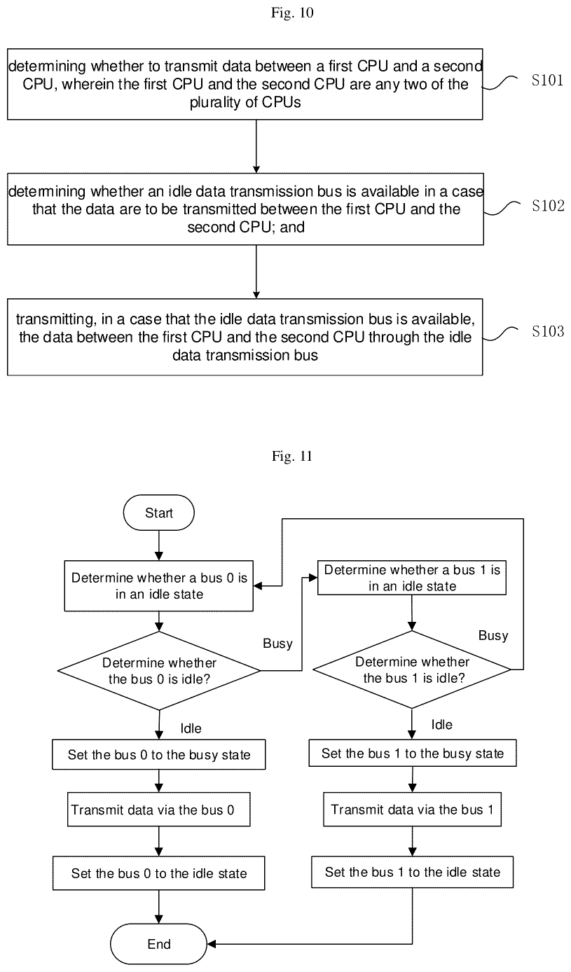

In a third aspect, a first configuration method is provided in the examples of the disclosure. The first configuration method is applied to the CPU in the server system. As shown in FIG. 10, the first configuration method includes:
S101: determining whether to transmit data between a first CPU and a second CPU, wherein the first CPU and the second CPU are any two of the plurality of CPUs;
S102: determining whether an idle data transmission bus is available in a case that the data are to be transmitted between the first CPU and the second CPU; and
S103: transmitting, in a case that the idle data transmission bus is available, the data between the first CPU and the second CPU through the idle data transmission bus.

With the above arrangement, the CPU determines whether the idle data transmission bus is available by itself, and if yes, occupies the idle data transmission bus, so as to transmit the data between the two CPUs. The two CPUs are in a direct connection state, so as to ensure rapidness of data transmission between the two CPUs.

In some examples, the step that in a case that the idle data transmission bus is available, the data are transmitted between the first CPU and the second CPU through the idle data transmission bus includes:
in a case that a plurality of idle data transmission buses are available, one idle data transmission bus is selected from the plurality of idle data transmission buses; and
the data are transmitted between the first CPU and the second CPU through the one idle data transmission bus which is selected from the plurality of idle data transmission buses.

In other words, in a case that the plurality of data transmission buses are available, one of the plurality of data transmission buses may be selected to prevent incorrect transmission.

An optional implementation is shown in FIGS. 2 and 11, in a case that the data are to be transmitted between the two CPUs, it is first determined whether a bus 0 is idle. In a case that the bus 0 is idle, the bus 0 is set to a busy state, and the data are transmitted through the bus 0. In a case that the bus 0 is not idle, whether a bus 1 is idle continues to be determined in the same way as the bus 0. In a case that the bus 0 and the bus 1 are busy, a waiting state is entered until an idle bus is available for data transmission. It is concluded that a bus-type inter-CPU data transmission bandwidth is shared by the plurality of CPUs in the server. The data transmission between the CPUs is mainly data transmission between memories. After the advent of the extended memory, a local memory of the CPU is greatly extended, so that data access across CPUs is greatly reduced. Thus, data transmission pressure of the bus between the CPUs can be significantly reduced. Accordingly, a number of CPUs in one server can be greatly increased, and a degree of coupling between the CPUs can be lowered, so as to prepare for pooling of CPU resources.

In some examples, the step that it is determined whether an idle data transmission bus is available includes:
a level signal at a preset position of each data transmission bus is acquired; and
it is determined whether the corresponding data transmission bus is the idle data transmission bus according to the level signal at the preset position of the each data transmission bus.

For example, in a case that a head portion of the bus is at a higher level, it is determined that the bus is a busy state, and in a case that a head portion of the bus is at a lower level, it is determined that the bus is an idle state. Whether the transmission bus is in the busy state or the idle state is determined briefly through the level.

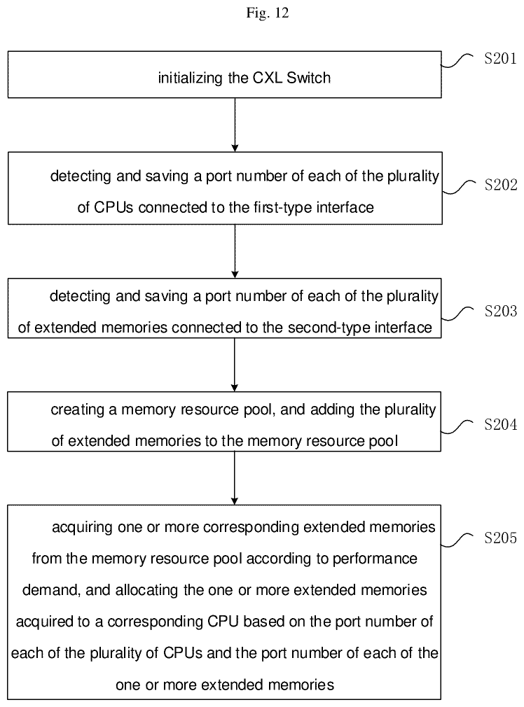

In a fourth aspect, a second configuration method is provided in the examples of the disclosure. The second configuration method is applied to the control module in the server system. The server system further includes the control module, and the control module is connected to each of the plurality of extended memories, the CXL Switch, and each of the plurality of CPUs respectively. As shown in FIG. 12, the second configuration method includes:
S201: initializing the CXL Switch.
S202: detecting and saving a port number of each of the plurality of CPUs connected to the first-type interface.

For example, there are five CPUs, i.e. a CPU 0, a CPU 1, a CPU 2, a CPU 3, and a CPU 4 with corresponding port numbers of 001, 002, 003, 004, and 005 respectively.
S203: detecting and saving a port number of each of the plurality of extended memories connected to the second-type interface.

For example, there are five extended memories, i.e. M0, M1, M2, M3, and M4 with corresponding port numbers of 0001, 0002, 0003, 0004, and 0005 respectively.
S204: creating a memory resource pool, and adding the plurality of extended memories to the memory resource pool.

In some examples, the M0, the M1, the M2, the M3, and the M4 with the port numbers of 0001, 0002, 0003, 0004, and 0005 respectively are added to the memory resource pool.
S205: acquiring one or more corresponding extended memories from the memory resource pool according to performance demand, and allocating the one or more extended memories acquired to a corresponding CPU of the plurality of CPUs based on the port number of each of the plurality of CPUs and the port number of each of the one or more extended memories.

For example, in a case that the CPU 0 needs to be configured with two extended memories according to performance demand, and the M0 and the M1 are found to be available, the M0 and the M1 may be allocated to the CPU 0. In other words, a correspondence relation between 0001 as well as 0002 and 0001 is established.

According to the configuration method applied to the control module in the server system of the disclosure, through the step that the compute express link switch is initialized, the step that a port number of a CPU is detected and saved, the step that a port number of an extended memory is detected and saved, and the step that a resource pool is created, the corresponding extended memory is finally allocated to the CPU.

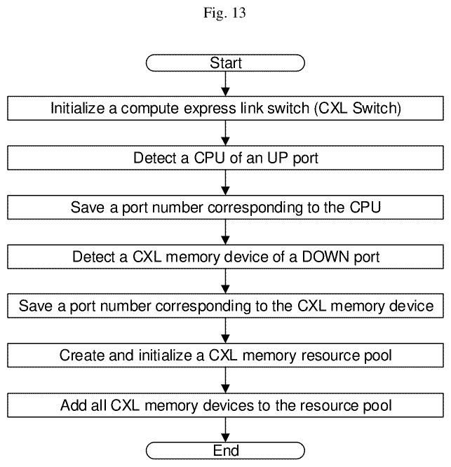

In an optional implementation, as shown in FIG. 13, the CXL Switch is selected as the compute express link switch, the first-type interface is denoted as an UP port, the second-type interface is denoted as an UP port and a DOWN port, the extended memory is selected as the extended memory, and the extended memory resource pool is selected as the memory resource pool as follows:

The CXL Switch is initialized. A CPU of the UP port is detected. A port number corresponding to the CPU is saved. An extended memory of the DOWN port is detected. A port number corresponding to the extended memory is saved. The extended memory resource pool is created and initialized. All the extended memories are added to the resource pool. In other words, after the CXL Switch is completely initialized, connection between the CPU and the extended memory extension device can be dynamically set through software. The extended memory is in a deenergized state before connected to the CPU. After the CXL Switch configures the extended memory completely, the CPU is connected to the extended memory extension device. The extended memory needs to be energized, and the CPU is finally triggered to load the device. After the above steps are completed, the CPU can use the extended memory. Correspondingly, in a case that the CPU does not need one extended memory, or hot-removes and deenergizes the device, the CXL Switch may allocate the extended memory to other CPUs for use. In this way, the extended memory is equivalent to one resource pool. The server organizes all the extended memories as the resource pool for unified management. When the CPU needs the memory resource, the idle extended memory may be taken from the extended memory resource pool, and allocated to the CPU. When the memory resource of the CPU is idle, the CPU must release the extended memory, and return the extended memory to the extended memory resource pool. All the extended memory resources are idle at the time of initialization.

The extended memory resource pool and its management function, the initialization of the CXL Switch, and the connection between the CPU and the extended memory are completed by a management system other than the CPU, such as the BMC.

Further, the method further includes:
it is determined whether a use rate of one or more extended memories allocated to a target CPU exceeds a preset use rate, where the target CPU is one of the plurality of CPUs, and the use rate indicates a proportion of the number of one or more extended memories being used by the target CPU to a total number of the one or more extended memories allocated to the target CPU, and/or a proportion of a space of the one or more extended memories being used by the target CPU to a total space of the on or more extended memories allocated to the target CPU; and
one or more new extended memory are applied for from the memory resource pool for the target CPU in a case that the use rate of one or more extended memories allocated to a target CPU exceeds the preset use rate.

One or more new extended memories may be provided.

In other words, if the use rate of the extended memory configured under the target CPU exceeds a preset threshold, in order to ensure normal implementation of the function, the new extended memory may be applied for the target CPU.

Further, after the step that one or more new extended memories are applied for from the memory resource pool for the target CPU, the method further includes:
it is determined whether an idle extended memory is available in the memory resource pool, and if the idle extended memory is available in the memory resource pool, the idle extended memory is acquired from the memory resource pool and a port number of the idle extended memory is acquired; and
a port number of the target CPU is acquired, and the port number of the idle extended memory is matched with the port number of the target CPU, so as to allocate the idle extended memory to the target CPU.

In other words, an instruction to apply for the new extended memory is initiated at first. Then, it is determined whether the idle extended memory is available in the memory resource pool. In some cases, the idle extended memory is allocated to the target CPU in a port number pairing mode.

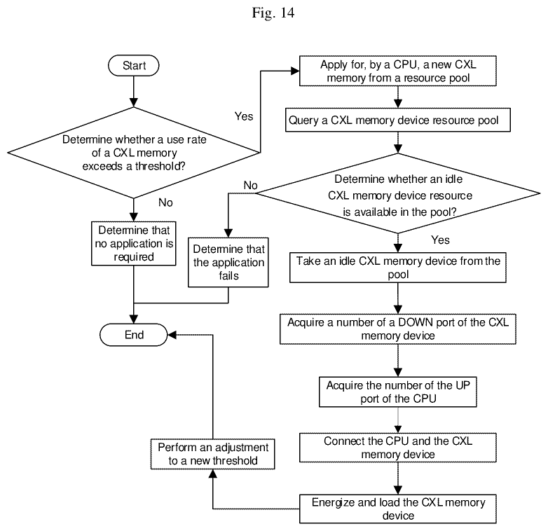

In an optional implementation, as shown in FIG. 14, it is determined whether the use rate of the extended memory exceeds a threshold. If yes, the CPU applies for the new extended memory from the resource pool. By querying the extended memory resource pool, in a case that the idle extended memory is available in the pool, the number of the DOWN port of the extended memory is acquired, and the number of the UP port of the CPU is acquired. The CPU is connected to the extended memory, and the extended memory is energized and loaded (energized herein indicates that only the extended memory is energized). An entire system maintains a charged state. After the extended memory is energized and loaded, an adjustment to a new threshold is performed.

Further, the method further includes:
it is determined whether an idleness rate of each of the one or more extended memories allocated to a target CPU exceeds a preset idleness rate, where the target CPU is one of the plurality of CPUs, and the idleness rate indicates a proportion of unused space of each of the one or more extended memories allocated to the target CPU to total space of each of the one or more extended memories allocated to the target CPU; and
in a case that the idleness rate of each of the one or more extended memories allocated to the target CPU exceeds the preset idleness rate, an allocation relation between the one or more extended memories, of which the idleness rate exceeding the preset idleness rate, and the target CPU is released.

In other words, when the idleness rate of the extended memory exceeds an idleness rate threshold, the extended memory needs to be released for use by other CPUs.

Further, the step that an allocation relation between the one or more extended memories, of which the idleness rate exceeds the preset idleness rate, and the target CPU is released includes:
the power off operation on the one or more extended memories of which the idleness rate exceeds the preset idleness rate is performed; and
the one or more extended memories on which the power off operation is performed is reclaimed into the memory resource pool, so as to release the allocation relation between the one or more extended memories, of which the idleness rate exceeds the preset idleness rate, and the target CPU.

In other words, the allocation relation between the one or more extended memories, of which the idleness rate exceeds the preset idleness rate, and the target CPU is released by performing the power off operation on the extended memory alone, and then reclaiming the extended memory. That is to say, release is implemented on the basis of a function of being hot-swappable of the extended memory.

In some examples, the step that an allocation relation between the one or more extended memories, of which the idleness rate exceeds the preset idleness rate, and the target CPU includes:
an extended memory of which the idleness rate is highest is determined; and
an allocation relation between the extended memory, of which the idleness rate is highest, and the target CPU is released.

The highest idleness rate may indicate that the extended memory is absolutely idle or has a small number of data. In a case that the extended memory is absolutely idle, the allocation relation may be directly released without data migration. In a case that the extended memory has a small number of data, little time is consumed even if data migration is performed, so that convenience and rapidness are achieved.

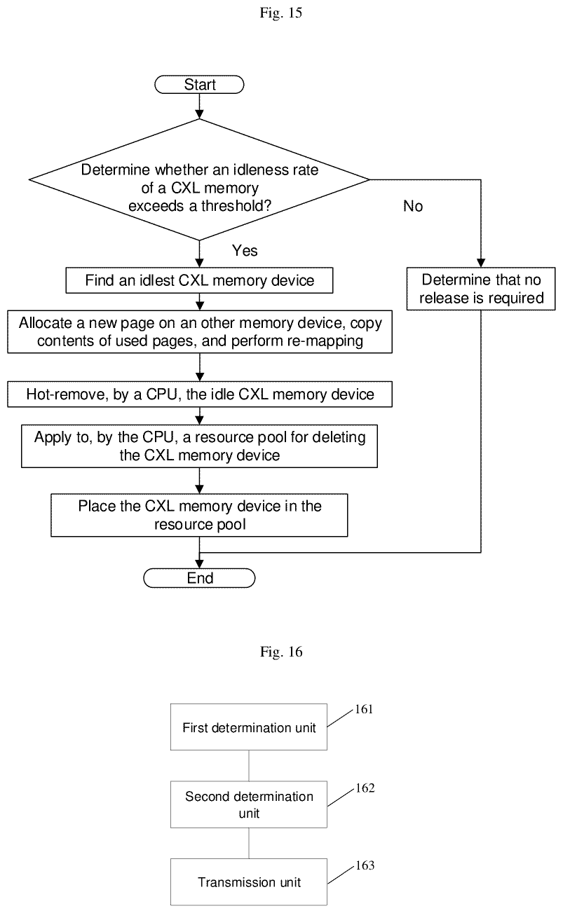

In some optional implementations, as shown in FIG. 15, it is determined whether the idleness rate of the extended memory exceeds the threshold. If no, no release is required. If yes, the idlest extended memory is found, new pages are allocated on other memory devices, contents of used pages are copied, and re-mapping is performed. The CPU hot-removes the idle extended memory, and applies to the resource pool for deleting the extended memory. Finally, the extended memory is placed into the resource pool.

Further, the method further includes:
at least one of the plurality of CPUs and at least one of the plurality of extended memories are combined into one server unit according to performance demand, so as to obtain a plurality of server units; and
the plurality of the server units are controlled to be run in parallel, so that a plurality of functions are implemented to satisfy the performance demand.

In other words, the control module may combine the CPU and the extended memory according to the performance demand. It can be deemed that the all the CPUs and all the extended memories are formed into a computer system. Alternatively, it can be deemed that all or some of the CPUs and all or some of the extended memories are formed into a plurality of computer systems as demanded.

In a fifth aspect, a CPU in a server system is provided in the examples of the disclosure. As shown in FIG. 16, the CPU includes:
a first determination unit 161 configured to determine whether to transmit data between a first CPU and a second CPU, where the first CPU and the second CPU are any two of a plurality of CPUs;
a second determination unit 162 configured to determine whether an idle data transmission bus is available in a case that the data are to be transmitted between the first CPU and the second CPU; and
a transmission unit 163 configured to transmit, in a case that the idle data transmission bus is available, the data between the first CPU and the second CPU through the idle data transmission bus.

The CPU in the server system of the disclosure determines whether the idle data transmission bus is available by itself, and in a case that the idle data transmission bus is available, occupies the idle data transmission bus, so that the data are transmitted between the two CPUs. The two CPUs are in a direct connection state, so as to ensure rapidness of data transmission between the two CPUs.

Further, the transmission unit includes a selection module and a transmission module. The selection module is configured to select, in a case that a plurality of idle data transmission buses are available, one idle data transmission bus. The transmission module is configured to transmit the data between the first CPU and the second CPU through the one idle data transmission bus selected.

Further, the second determination unit includes an acquisition module and a first determination module. The acquisition module is configured to acquire a level signal at a preset position of each data transmission bus. The first determination module is configured to determine whether the corresponding data transmission bus is the idle data transmission bus according to the level signal.

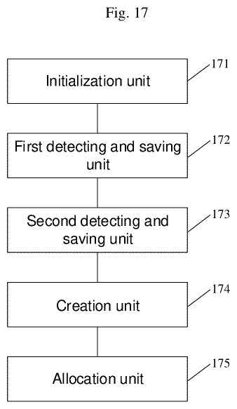

In a sixth aspect, a control module in a server system is provided in the examples of the disclosure. The server system further includes a plurality of extended memories and a compute express link switch, where the compute express link switch is connected to each CPU through a first-type interface and connected to each extended memory through a second-type interface. As shown in FIG. 17, the control module includes:
an initialization unit 171 configured to initialize the compute express link switch;
a first detecting and saving unit 172 configured to detect and save a port number of each of the plurality of CPUs connected to the first-type interface;
a second detecting and saving unit 173 configured to detect and save a port number each of the extended memory connected to the second-type interface;
a creation unit 174 configured to create a memory resource pool, and add all extended memories to the memory resource pool; and
an allocation unit 175 configured to acquire one or more corresponding extended memories from the memory resource pool according to performance demand, and allocate the one or more extended memories acquired to the corresponding CPU based on the port number of each of the plurality of CPUs and the port number of each of the plurality of extended memories.

Through the step of initializing the compute express link switch, the step of detecting and saving a port number of the CPU, the step of detecting and saving a port number of the extended memory, and the step of creating a resource pool, the control module in the server system of the disclosure finally allocates the corresponding extended memory to the CPU.

Further, the control module further includes a third determination unit and an application unit. The third determination unit is configured to determine whether a use rate of one or more extended memories allocated to a target CPU exceeds a preset use rate, where the target CPU is one of the plurality of CPUs, and the use rate indicates a proportion of the number of one or more extended memories being used by the target CPU to a total number of the one or more extended memories allocated to the target CPU, and/or a proportion of a space of the one or more extended memories being used by the target CPU to a total space of the on or more extended memories allocated to the target CPU. The application unit is configured to apply for one or more new extended memory from the memory resource pool for the target CPU in a case that the use rate of one or more extended memories allocated to a target CPU exceeds the preset use rate.

Further, the control module further includes a fourth determination unit and an acquisition unit. The fourth determination unit is configured to determine whether an idle extended memory is available in the memory resource pool after one or more new extended memories are applied for from the memory resource pool for the target CPU, and if the idle extended memory is available in the memory resource pool, acquire the idle extended memory from the memory resource pool and a port number of the idle extended memory. The acquisition unit is configured to acquire a port number of the target CPU, and match the port number of the idle extended memory with the port number of the target CPU, so as to allocate the idle extended memory to the target CPU.

Further, the control module further includes a fifth determination unit and a release unit. The fifth determination unit is configured to determine whether an idleness rate of each of the one or more extended memories allocated to a target CPU exceeds a preset idleness rate, where the target CPU is one of the plurality of CPUs, and the idleness rate indicates a proportion of unused space of each of the one or more extended memories allocated to the target CPU to total space of each of the one or more extended memories allocated to the target CPU. The release unit is configured to release, in a case that the idleness rate of the extended memory configured under the target CPU exceeds the preset idleness rate, an allocation relation between the extended memory having the idleness rate exceeding the preset idleness rate and the target CPU.

Further, the release unit includes a performance module and a reclamation module. The performance module is configured to deenergize (namely, perform a power off operation) the one or more extended memories of which the idleness rate exceeds the preset idleness rate. The reclamation module is configured to reclaim the one or more extended memories on which the power off operation is performed into the memory resource pool, so as to release the allocation relation between one or more extended memories, of which the idleness rate exceeds the preset idleness rate, and the target CPU.

Further, the release unit includes a second determination module and a release module. The second determination module is configured to determine an extended memory of which the idleness rate is highest. The release module is configured to release an allocation relation between the extended memory, of which the idleness rate is highest, and the target CPU.

Further, the control module further includes a combination unit and a control unit. The combination unit is configured to combine at least one of the plurality of CPUs and at least one of the plurality of extended memories into one server unit, so as to obtain a plurality of server units. The control unit is configured to control the plurality of server units to be run in parallel to implement one or more functions, so that the performance demand is satisfied.

It should be noted that each module described above can be implemented through software or hardware. In the latter case, the above modules are positioned in a same processor or the above modules are separately positioned in different processors in any combinations, which is not restrictive.

A non-volatile readable storage medium is further provided in the examples of the disclosure. The non-volatile readable storage medium stores a computer program, where the computer program executes steps in any method example described above when run.

In an illustrative example, the above non-volatile readable storage medium may include, but is not limited to, various media capable of storing a computer program, such as a universal serial bus (USB) flash disk, a read-only memory (ROM), a random access memory (RAM), a mobile hard disk, a magnetic disk, and an optical disk.

An electronic device is further provided in the examples of the disclosure. The electronic device includes a memory and a processor, where the memory stores a computer program, and the processor is configured to execute steps in any method example described above when running the computer program.

In an illustrative example, the above electronic device may further include a transmission device and an input/output device, where the transmission device is connected to the above processor, and the input/output device is connected to the above processor.

Reference can be made to the instances described in the above examples and the illustrative embodiments for the instances in the example, which will not be repeated herein in the example.

Apparently, those skilled in the art should understand that all the modules or steps above of the disclosure can be implemented through a general-purpose computation apparatus, centralized on a single computation apparatus or distributed over a network composed of a plurality of computation apparatuses, and implemented through program codes executable by the computation apparatus. Thus, the modules or steps can be stored in a storage apparatus to be executed by the computation apparatus. In some cases, the steps shown or described can be executed in orders other than those herein or fabricated into individual integrated circuit modules. Alternatively, some or all of the modules or the steps can be implemented by fabricating them into individual integrated circuit modules separately. In this way, the disclosure is not limited to any particular combination of hardware and software.

What are described above are merely preferred examples of the disclosure, and are not intended to limit the disclosure. Those skilled in the art can make various changes and variations to the disclosure. Any modifications, equivalent replacements, improvements, etc. made within the principles of the disclosure should fall within the scope of protection of the disclosure.

1. A server system, comprising:
a plurality of central processing units (CPUs), wherein each of the plurality of CPUs is provided with at least one bus interface;
at least one data transmission bus, wherein each of the plurality of CPUs is connected to one or more of the at least one data transmission bus through one or more corresponding bus interfaces of the at least one bus interface, and any two of the plurality of CPUs are configured to transmit data through one or more of the at least one data transmission bus;
a plurality of extended memories based on a compute express link (CXL); and
a compute express link switch (CXL Switch), which has an memory resource allocation module, wherein the CXL Switch is provided with a first-type interface and a second-type interface, and the CXL Switch is connected to each of the plurality of CPUs through the first-type interface and connected to each of the plurality of extended memories through the second-type interface; the CXL Switch is configured to connect a target extended memory with a target CPU via a data path under an indication of a connection signal, so as to allocate the target extended memory to the target CPU; and the target extended memory is one or more of the plurality of extended memories, and the target CPU is one of the plurality of CPUs.

2. The server system according to claim 1, wherein the CXL Switch comprises:
a plurality of CXL sub-Switches in cascaded, wherein each of the plurality of CXL sub-Switches is provided with the first-type interface and the second-type interface; one CXL sub-Switch of the plurality of CXL sub-Switches is connected to each of the plurality of CPUs through the first-type interface of the one CXL sub-Switch, and one CXL sub-Switch of the plurality of CXL sub-Switches is connected to each of the plurality of extended memories through the second-type interface of the one CXL sub-Switch; and the second-type interface of a CXL sub-Switch at a first level of two mutually-cascaded levels is connected to the first-type interface of a CXL sub-Switch at a second level of the two mutually-cascaded levels.

3. The server system according to claim 1, wherein the server system further comprises:
a control module, wherein the control module is connected to each of the plurality of extended memories, the CXL Switch, and each of the plurality of CPUs respectively, and the control module is configured to allocate a corresponding extended memory to each of the plurality of CPUs, and the control module is further configured to combine at least one of the plurality of CPUs and at least one of the plurality of extended memories into a server unit, to obtain a plurality of server units, so that one or more functions are implemented through the plurality of server units.

4. The server system according to claim 1, wherein the server system further comprises:
a front panel;
a backplane; and
a CPU board, wherein the CPU board is sandwiched between the front panel and the backplane, the plurality of CPUs and the at least one data transmission bus are integrated in the CPU board, and the CPU board is connected to the backplane through a first board interface positioned on the backplane.

5. The server system according to claim 4, wherein the server system further comprises:
one or more memory boards, wherein a plurality of extended memories and a CXL Switch are integrated on the one or more memory boards, and each of the one or more memory boards is sandwiched between the front panel and the backplane, and each of the one or more memory boards is connected to the backplane through a second board interface positioned on the backplane.

6. The server system according to claim 4, wherein the server system further comprises:
a control board, wherein a control module is integrated on the control board, and the control board is sandwiched between the front panel and the backplane; and the control board is connected to the backplane through a third board interface positioned on the backplane, and the control module is connected to each of the plurality of extended memories, the CXL Switch, and each of the plurality of CPUs respectively.

7. The server system according to claim 4, wherein the server system further comprises:
a power source board, wherein the power source board is sandwiched between the front panel and the backplane, and the power source board is connected to the backplane through a fourth board interface positioned on the backplane, and the power source board is configured to provide electrical energy for the server system.

8. The server system according to claim 4, wherein a display unit and a control switch are integrated on the front panel.

9. A configuration method applied for a CPU in the server system according to claim 1, comprising:
determining whether to transmit data between a first CPU and a second CPU, wherein the first CPU and the second CPU are any two of the plurality of CPUs;
determining whether an idle data transmission bus is available in a case that the data are to be transmitted between the first CPU and the second CPU; and
transmitting, in a case that the idle data transmission bus is available, the data between the first CPU and the second CPU through the idle data transmission bus.

10. The configuration method according to claim 9, wherein the transmitting, in a case that the idle data transmission bus is available, the data between the first CPU and the second CPU through the idle data transmission bus comprises:
selecting, in a case that a plurality of idle data transmission buses are available, one idle data transmission bus from the plurality of idle data transmission buses; and
transmitting the data between the first CPU and the second CPU through the one idle data transmission bus which is selected from the plurality of idle data transmission buses.

11. The configuration method according to claim 9, wherein the determining whether an idle data transmission bus is available comprises:
acquiring a level signal at a preset position of each data transmission bus; and
determining whether the each data transmission bus is the idle data transmission bus according to the level signal at the preset position of the each data transmission bus.

12. A configuration method applied for a control module in the server system according to claim 1, wherein the server system further comprises a control module, and the control module is connected to each of the plurality of extended memories, the CXL Switch, and each of the plurality of CPUs respectively; and the configuration method comprises:
initializing the CXL Switch;
detecting and saving a port number of each of the plurality of CPUs connected to the first-type interface;
detecting and saving a port number of each of the plurality of extended memories connected to the second-type interface;
creating a memory resource pool, and adding the plurality of extended memories to the memory resource pool; and
acquiring one or more corresponding extended memories from the memory resource pool according to performance demand, and allocating the one or more extended memories acquired to a corresponding CPU of the plurality of CPUs based on the port number of each of the plurality of CPUs and the port number of each of the one or more extended memories.

13. The configuration method according to claim 12, further comprising:
determining whether a use rate of one or more extended memories allocated to a target CPU of the plurality of CPUs exceeds a preset use rate, wherein the use rate indicates a proportion of the number of one or more extended memories being used by the target CPU to a total number of the one or more extended memories allocated to the target CPU, and/or a proportion of a space of the one or more extended memories being used by the target CPU to a total space of the on or more extended memories allocated to the target CPU; and
applying for one or more new extended memories from the memory resource pool for the target CPU in a case that the use rate exceeds the preset use rate.

14. The configuration method according to claim 13, wherein after the applying for one or more new extended memories from the memory resource pool for the target CPU, the method further comprises:
determining whether an idle extended memory is available in the memory resource pool, and if the idle extended memory is available in the memory resource pool, acquiring the idle extended memory from the memory resource pool, and acquiring a port number of the idle extended memory; and
acquiring a port number of the target CPU, and matching the port number of the idle extended memory with the port number of the target CPU, so as to allocate the idle extended memory to the target CPU.

15. The configuration method according to claim 12, further comprising:
determining whether an idleness rate of each of the one or more extended memories allocated to a target CPU exceeds a preset idleness rate, wherein the idleness rate indicates a proportion of unused space of each of the one or more extended memories allocated to the target CPU to total space of each of the one or more extended memories allocated to the target CPU; and
releasing, in a case that the idleness rate exceeds the preset idleness rate, an allocation relation between one or more extended memories, of each of which the idleness rate exceeds the preset idleness rate, and the target CPU.

16. The configuration method according to claim 15, wherein the releasing an allocation relation between the one or more extended memories, of each of which the idleness rate exceeds the preset idleness rate, and the target CPU comprises:
performing a power off operation on the one or more extended memories of each of which the idleness rate exceeds the preset idleness rate; and
reclaiming the one or more extended memories on which the power off operation is performed into the memory resource pool, so as to release the allocation relation between the one or more extended memories, of which the idleness rate exceeds the preset idleness rate, and the target CPU.

17. The configuration method according to claim 15, wherein the releasing an allocation relation between the one or more extended memories, of each of which the idleness rate exceeds the preset idleness rate, and the target CPU comprises:
determining an extended memory, of which the idleness rate is highest, from the one or more extended memories, of each of which the idleness rate exceeds the preset idleness rate; and
releasing an allocation relation between the extended memory, of which the idleness rate is highest, and the target CPU.

18. The configuration method according to claim 12, further comprising:
combining at least one of the plurality of CPUs and at least one of the plurality of extended memories into one server unit, so as to obtain a plurality of server units; and
controlling the plurality of server units to be run in parallel to implement one or more functions.

19. A CPU in the server system according to claim 1, comprising:
a first determination unit configured to determine whether to transmit data between a first CPU and a second CPU, wherein the first CPU and the second CPU are any two of the plurality of CPUs;
a second determination unit configured to determine whether an idle data transmission bus is available in a case that the data are to be transmitted between the first CPU and the second CPU; and
a transmission unit configured to transmit, in a case that the idle data transmission bus is available, the data between the first CPU and the second CPU through the idle data transmission bus.

20. A control module in the server system according to claim 1, wherein the server system further comprises a control module, and the control module is connected to each of the plurality of extended memories, the CXL Switch, and each of the plurality of CPUs separately; and the control module comprises:
an initialization unit configured to initialize the CXL Switch;
a first detecting and saving unit configured to detect and save a port number of each of the plurality of CPUs connected to the first-type interface;
a second detecting and saving unit configured to detect and save a port number of each of the plurality of extended memories connected to the second-type interface;
a creation unit configured to create a memory resource pool, and add the plurality of extended memories to the memory resource pool; and
an allocation unit configured to acquire one or more corresponding extended memories from the memory resource pool according to performance demand, and allocate the one or more extended memories acquired to a corresponding CPU based on the port number of each of the plurality of CPUs and the port number of each of the plurality of extended memories.

21. (canceled)
